(19) United States
(12) Patent Application Publication
(10) Pub. No.: US 2023/0260039 A1
(43) Pub. Date: Aug. 17, 2023

(54) Strike Price Monitoring Service

(71) Applicant: PRINCIPAL FINANCIAL SERVICES, INC., Des Moines, IA (US)

(72) Inventors: Abby Lynn Neill, Ankeny, IA (US); Alex Michael Vander Stoep, Waukee, IA (US); Justin Sell, Ankeny, IA (US); Clark Blackford, Cumming, IA (US); Michelle Rosel, Waukee, IA (US); Christopher Steven Johnson, Ankeny, IA (US); Timothy Andrew Lewis, Urbandale, IA (US); Joseph William McCarty, Waukee, IA (US); Michael E. Clark, Pittsburgh, PA (US); Sumit Kundu, Wellesley, MA (US); Barry Freiman, Marietta, GA (US); Justina Loeb, West Des Moines, IA (US); Chelsie Modlin, Newton, IA (US)

(73) Assignee: PRINCIPAL FINANCIAL SERVICES, INC., Des Moines, IA (US)

(21) Appl. No.: 17/669,901

(22) Filed: Feb. 11, 2022

(51) Int. Cl. G06Q 40/08; G06Q 40/06; G06Q 30/02

(52) U.S. Cl. CPC G06Q 40/08; G06Q 40/06; G06Q 30/0283

(57) ABSTRACT

A computer-implemented method executed by at least one processor includes steps of communicating over a computer network a plurality of inputs to a pension risk transfer pricing service, the plurality of inputs including pension plan census data, applying by the pension risk transfer pricing service a computer-implemented pension risk transfer model for generating pension risk transfer pricing, and providing through the pension risk transfer pricing service a user interface for interacting with a user by communicating the pension risk transfer pricing and investments to the user and the user interface configured such that the user is able to strike the pension risk transfer at the pension risk transfer pricing.

### FIELD OF THE INVENTION

The present invention relates to data processing and more specifically, but without limitation, to monitoring strike price for a transfer of pension liability associated with a defined benefit pension plan to an insurer.

### BACKGROUND OF THE ART

In recent years especially, companies with traditional pension plans have recognized that it can be highly advantageous for companies to reduce or transfer pension risk (de-risking). One significant reason is to avoid earnings volatility. Specific risks may include longevity risk encountered when participants outlive current annuity mortality table estimates, investment risk where rates of return on investment will not be as expected, and numerous other risks.

De-risking, in whatever form, typically involves complex strategies. Pension risk transfer (“PRT”) generally occurs when a defined benefit pension provider or plan sponsor reduces some or all of its risk associated with a pension plan such as by working with an insurance company to take on obligations for paying benefits such as by purchasing annuities, restructuring of plan investments, or otherwise. Examples of PRTs to de-risk may include a full plan termination or a lift-out of retirees.

Yet pension plan terminations carry their own risks and have significant governmental requirements. The complexity of these transactions and lack of a streamlined process results in increased risks, costs, and uncertainties for the company seeking to transfer risk. In part due to the complexity of these transaction, the current level of price transparency in the U.S. pension risk transfer market is very limited, providing only one or very few actual transactable prices over a multi-month period. Typical PRT transactions use a single day auction framework. There is a preliminary quote date and a final quote date with these dates being set in advance. Insurance companies who provide pension risk transfer services to plan sponsors will determine their pricing through their own proprietary actuarial models to provide a pricing quote on the preliminary quote date and to provide final pricing on the final quote date. Plan sponsors would only have access to PRT pricing on those two dates and only on the final quote date is a transactable price available.

It is common for pricing to be estimated by consultants who advise clients in this industry. However, these estimates may or may not be accurate and are not actual transactable prices. Similarly, there may be tools used by consultants or directly by clients to estimate PRT prices, but again any resulting prices are merely estimates as opposed to actual quotes.

From the perspective of plan sponsors seeking there is a need for enhancing the ability to monitor and avoid market interest rate volatility and to obtain a quote that fits their business and financial needs.

### SUMMARY

Therefore, it is a primary object, feature, or advantage of the present invention to improve over the state of the art.

It is a further object, feature, or advantage of the present invention to enhance the ability of plan sponsors to monitor and avoid market interest rate volatility and to obtain a quote that fits their business and financial needs.

It is a still further object, feature, or advantage to provide for de-risking solutions for companies with defined benefit pension plans.

It is another object, feature, or advantage to provide truly transactable price and thus true price transparency and not merely a mirage of one.

Yet another object, feature, or advantage is to provide the ability to compare pricing to client determined benchmarks.

A further object, feature, or advantage is to provide value to clients by enabling them to lock-in prices of PRT services at a time that is suitable to them, not merely on the day selected for the typical Single Day Auction.

A still further object, feature, or advantage is to develop sophisticated technology configured to obtain necessary information from disparate data sources in order to support PRT pricing models.

Yet another object, feature, or advantage is to compute and display to clients current pricing and historical data which they may use drive decision-making processes.

Another object, feature or advantage is to leverage technology in order to parameterize and apply PRT pricing models.

Yet another object, feature, or advantage is to provide for coordinated/customizable benchmarks from a single source.

A further object, feature, or advantage is to provide plan sponsors improved pricing/price optimization capabilities.

A still further object, feature or advantage is to provide significant value to plan sponsors by monitoring daily or periodically updated prices over a time period (e.g. months) as opposed to receiving a single price from several insurers as a part of a single-day auction.

Another object, feature, or advantage is to provide an actionable framework which allows clients to define clear transactions goals and execute on the goals.

Yet another object, feature, or advantage is to provide for robust scenario modeling including the ability to scenario model for the liability price as well as investment splits.

Another object, feature, or advantage is to provide a platform and marketplace for PRT pricing which allows for receiving multiple real-time bids from multiple providers.

A still further object, feature, or advantage is to provide a platform which allows for dividing a single PRT transaction into a plurality of micro-transactions and use AI to systematically execute them over a period of time using a variety of factors to optimize economics.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by any objects, features, or advantages stated herein.

According to one aspect, a computer-implemented method executed by at least one processor is provided which includes steps of communicating over a computer network a plurality of inputs to a pension risk transfer pricing service, the plurality of inputs including pension plan census data, applying by the pension risk transfer pricing service a computer-implemented pension risk transfer model for generating pension risk transfer pricing, and providing through the pension risk transfer pricing service a user interface for interacting with a user by communicating the pension risk transfer pricing and investments to the user and the user interface configured such that the user is able to strike the pension risk transfer at the pension risk transfer pricing.

According to another aspect, a computer-implemented method performed using at least one processor. The method includes communicating over a computer network a plurality of inputs to a pension risk transfer pricing service for a pension plan, the plurality of inputs including pension plan census data, applying by the pension risk transfer pricing service a computer-implemented pension risk transfer model for generating pension risk transfer pricing for the pension plan, providing through the pension risk transfer pricing service a user interface for interacting with a user by communicating the pension risk transfer pricing and investments to the user and the user interface configured such that the user is able to strike the pension risk transfer at the pension risk transfer pricing, and providing through the user interface benchmarking functionality to select a benchmark and to visually display a comparison of the pension risk transfer pricing to the benchmark. The method may further include providing through the user interface goal selection functionality to visually display pricing relative to a defined goal, providing through the user interface scenario planning functionality to visually display multiple scenarios based on alternative assumptions, providing through the user interface micro-transaction functionality to display assets and/or liabilities of the pension plan at a granular level, and providing through the user interface additional benchmarking functionality to visually compare the pension plan with actual cost history from other pension plans.

### BRIEF DESCRIPTION OF THE FIGURES

FIG. 1 is a block diagram of one example of a system which provides a pension risk transfer pricing service.

FIG. 2 is a diagram of one example of a process which may be performed by the system of FIG. 1 or otherwise.

FIG. 3 illustrates an example of information flow associated with a pension risk transfer pricing model.

FIG. 4 is a graph illustrating investment value and PRT pricing at different times.

FIG. 5 is a graph corresponding to FIG. 4 which illustrates cash outlay to purchase a PRT contract at different times.

FIG. 6 is a screen display of one example of a user interface showing assets and liabilities associated with a pension plan.

FIG. 7 illustrates an additional graph component as may be shown on a screen display associated with the user interface showing funded status.

FIG. 8 may be used as an additional graph component such as may be shown on a screen display associated with the user interface showing funded status movement.

FIG. 9 may be used as an additional graph component such as may be shown on a screen display associated with the user interface showing assets and liabilities.

FIG. 10 may be used as an additional graph component such as may be shown on a screen display associated with the user interface showing projected benefit obligations.

FIG. 11 may be used as an additional graph component such as may be shown on a screen display associated with the user interface.

FIG. 12 illustrates another example of a user interface in the form of a dashboard with multiple graph components.

FIG. 13 is a screen display showing price history, analysis, and price performance relative to a custom benchmark as well as scenario planning.

FIG. 14 is a screen display showing goals and objectives with dynamic backtesting as well as scenario planning.

FIG. 15 is a screen display showing one example of a micro transaction optimizer.

FIG. 16 is a screen display to shows additional benchmarking.

FIG. 17 is another example of a screen display for showing additional benchmarking.

### DETAILED DESCRIPTION

The present disclosure describes a service which may be used to monitor the PRT price, investment value, and cash outlay required to execute a PRT transaction. This allows clients or plan sponsors to monitor economics of a placement in real time. As a component of this service, clients are able to outline a desired goal, such as a target cash outlay, and a transaction can be executed in real time if that goal is met. Thus, the service enables defined benefit pension plan clients the opportunity to monitor in real time the cost required to transfer their pension liability to an insurance company. The current level of price transparency in the US pension risk transfer market is limited, providing only one or very few actual transactable prices over a multi month period. In contrast, this service will provide routine (up to daily) pricing that can be purchased in real time. This ability to monitor costs continuously enables plans to truly put into context the price and whether they are selecting the right time to transact or not. Most developed financial markets offer this degree of continuous prices for this reason, but the current US pension risk transfer market does not. It is common for pricing to be estimated by consultants who advise clients in this industry, but this service provides truly transactable prices. This is critical as the service is providing true price transparency and not merely a mirage of one. Additionally, this service provides the ability to compare pricing to client determined benchmarks. This additional benchmarking helps a client further understand if now is truly the right time to act.

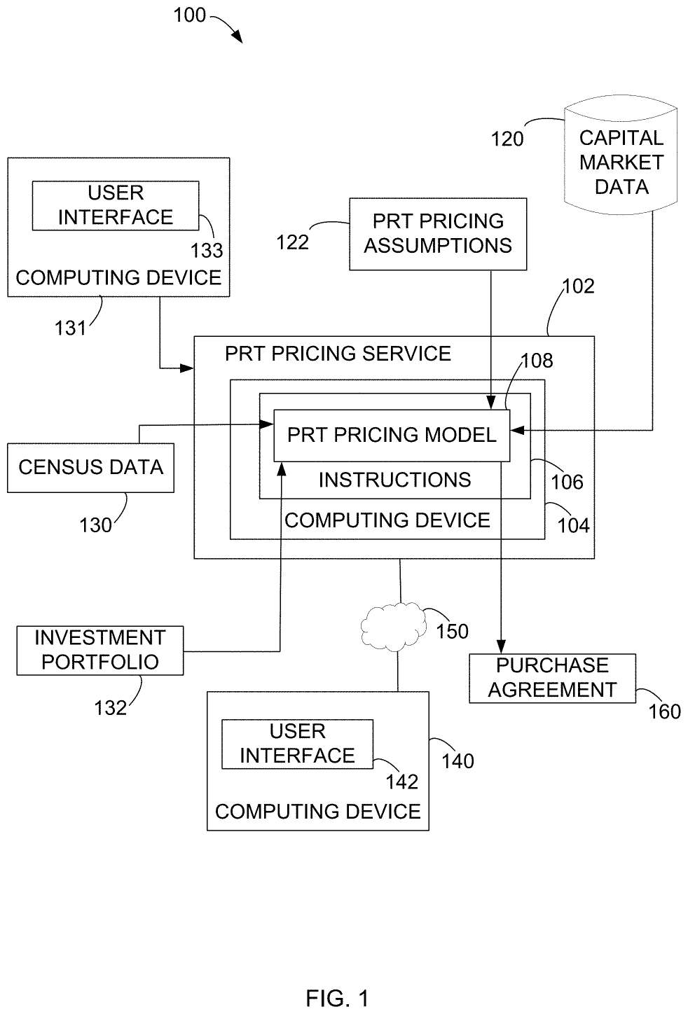

FIG. 1 illustrates one example of a system 100 which includes a pension risk transfer (“PRT”) pricing service 102. A computing device 104 is present which may be included a set of instructions 106 executed by a processor of the computing device 104 and stored on a machine-readable medium. The set of instructions 106 provide for implementing a PRT pricing model 108. The PRT pricing model 108 may be an actuarial or other statistical model used to provide a transactable price. The PRT pricing model 108 may provide its pricing based in part on capital market data 120 and PRT pricing assumptions 122 which may be input into the system. In addition, the PRT pricing mode 108 may receive as input census data 130 and investment portfolio data 132.

A computing device 131 may access the PRT pricing service 102 such as over a communications network. The computing device 131 may be associated with an insurer and may provide a user interface 133 configured for use by a user such as an employee or contractor of the insurer. Another computing device 140 is shown which may access the PRT pricing service 102 over a communications network such as the internet 150. The computing device 140 may be associated with a plan provider seeking a pension risk transfer transaction such as a plan sponsor. Such an organization may also be referred to as a client as they may be considered a client of the organization providing the PRT pricing service or a client of an insurer. The computing device 140 may have a user interface 142 configured for use by a user such as an employee, contractor, or consultant of the plan sponsor or client.

The user interface 142 may also be used to specify that output should be generated as a flat output such as a Microsoft PowerPoint presentation file, a PDF file, or other type of file or document.

The user interface 133 of the computing device 131 associated with the insurer or PRT pricing service and the user interface 142 of the computing device 140 associated with the client may be different. The PRT pricing service 102 may provide different types of user accounts with each type of account configured to have different permissions, different defaults, and different functionality consistent with the role of the user. As will later be discussed in more detail, the user interface 142 is preferably configured to simplify the user experience for the client while providing powerful functionality to meet their business goals and objectives. A part of this functionality is the ability to strike a contract at a desired time at a current pricing. Once a user completes this process, the system may automatically generate a purchase agreement 160 which may be executed by the client through the PRT pricing service 102.

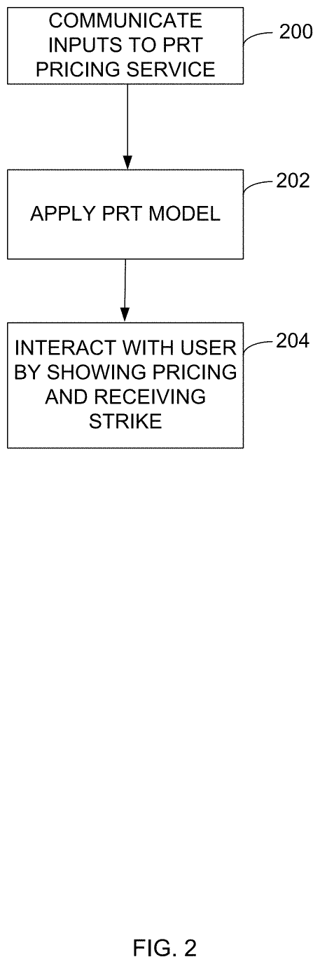

FIG. 2 illustrates one example of a general methodology which is provided. In step 200 inputs to the PRT pricing service are provided. These inputs may include pension plan census data, pension plan provisions, pension risk transfer pricing assumptions, and capital market data. These inputs may further include investment portfolio data. Examples of pension risk transfer pricing assumptions may include mortality assumptions, profitability targets, and current interest rates.

In step 202, the PRT model is applied based on the inputs. The PRT model may be a statistical model such as actuarial model which takes into account census data for members of a plan. In some embodiments, the PRT model may be implemented using R, although other languages or tools may be used as may be appropriate or expedient in a particular application or implementation.

In step 204, the PRT pricing services provides for interaction with the user in various ways. This may include providing a user interface showing current pricing for a PRT transaction and the ability to receive a strike or completion of the contract by a client at the current pricing.

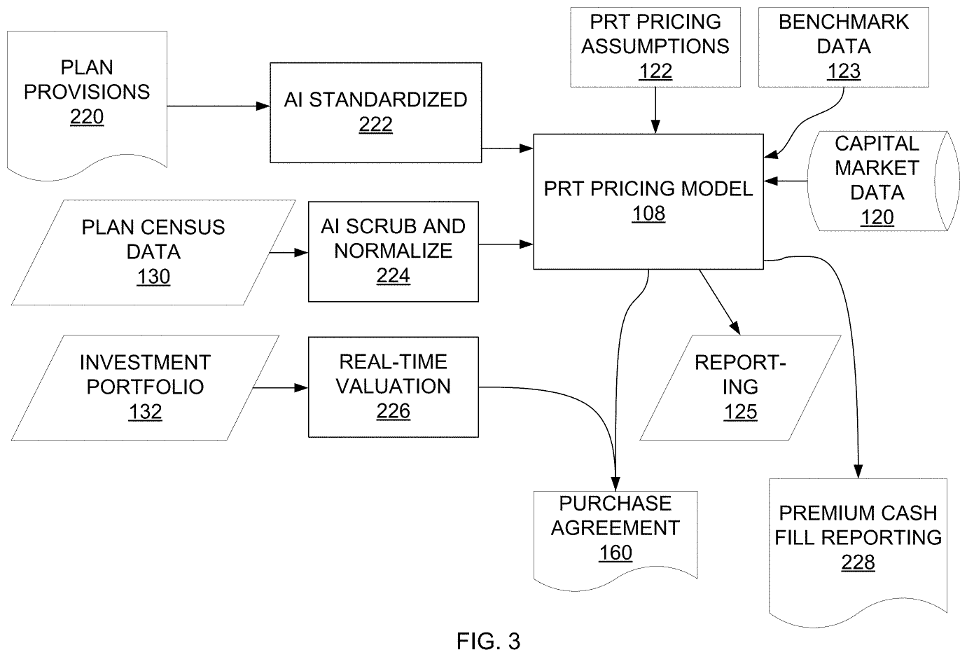

FIG. 3 further illustrates information flow. As shown in FIG. 3, plan provisions may be analyzed using artificial intelligence (AI) or machine learning to provided AI standardized provisions with an AI standardized provision component 222. The machine learning may for example, provide natural language processing, classification algorithms, or other types of algorithms for identifying plan provisions and classifying the plan provisions to provide AI standardized provisions. Plan census data 130 may be analyzed using artificial intelligence (AI) or machine learning to provide AI scrubbed and normalized data using an AI scrub and normalize component 224. This component 224 may, for example, be a software component implemented in python, R, or other programming language. The component 224 may apply algorithms such as transforms or other machine learning algorithms for removing duplicate data and otherwise cleaning data to provide a high quality data set. The investment portfolio 132 may be valued in real-time with a real-time valuation component 226. The PRT pricing model 108 is shown which may receive as input the plan provisions after standardization, plan census data after scrubbing and normalization, PRT pricing assumptions 122 and capital market data 120. The PRT pricing model 108 may also provide for a purchase agreement 160. Real-time valuation 226 also provides input for the purchase agreement 160. The PRT pricing model 108 also provides premium cash fill reporting 228. The PRT pricing model can also be used to generate customized benchmarks by feeding in separate assumptions (“PBO assumptions”), performing appropriate calculations, and creating output to be reported to the end user.

In FIG. 3, additional benchmark data 123 may be received. The benchmark data may come from any number of different sources or combinations of sources in addition to those sources already described. Any number of types of benchmarking may be supported. Examples of types of benchmarking may further include previous competitive bids on the same liability, economic basis benchmarking, pricing from a prior transaction benchmarking, hard dollar budget benchmarking, and maximum allowable before recognizing accounting events benchmarking.

The framework defined allows for creating of reporting 125. The reporting 125 may provide output in the form of reporting or calculating of any number of types including benchmarks that an end user may want to monitor to compare daily price to or otherwise make comparisons. The reporting may be presented through a user interface or may be in the form of a file output such as a Microsoft PowerPoint file, a pdf file, a csv file, a spreadsheet, a database, or other type of file.

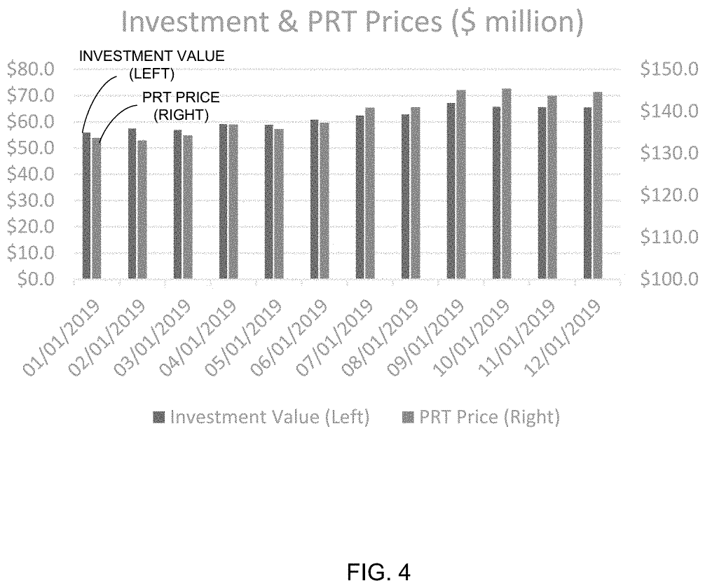

FIG. 4 is a bar graph showing an example of investment and PRT process for a plurality of different dates. For each day, both an investment value and a PRT price are shown. The investment value is the value of a portfolio of investments valued at current market price using commonly used market methods or other industry-accepted methods.

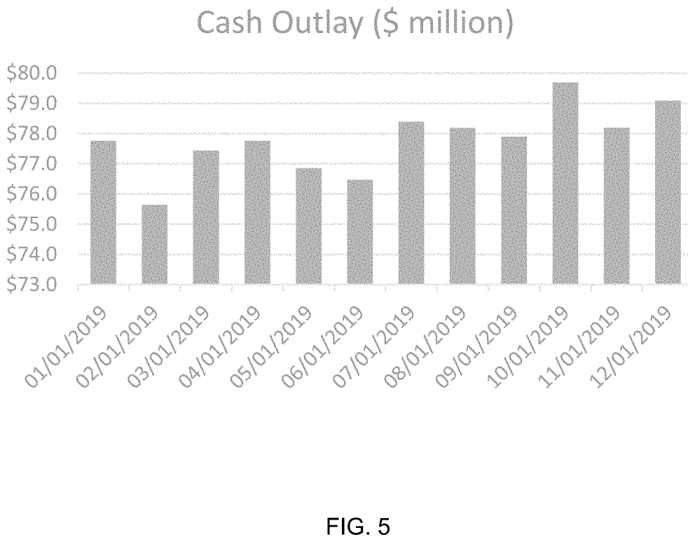

In PRT transactions, sometimes payment may be made in whole or in part through a portfolio of plan investments rather than cash which are considered assets-in-kind. When using assets-in-kind there may be an additional amount of money required to fund a PRT. This additional money may be considered a cash outlay or cash fill. In FIG. 4, note that there are significant variances in both investment value and PRT pricing over time. FIG. 5 illustrates the required cash outlay for PRT transactions for each of the dates. Note that there is also a significant cash outlay.

Suppose there was an October 2019 PRT placement corresponding to a PRT premium of $143.7 M with $65.7 M investment value of assets-in-kind and $78 M of cash fill. In a typical conventional process, a single day competitive bid process for Oct. 1, 2019 would result in this single pricing. However, in 7 of 12 months there would have been a final cash fill of less than $78 M and a total savings of up to $2.4 M to the plan.

Thus, FIG. 4 and FIG. 5 when taken together make clear that timing can have a significant effect on the cash outlay required for a PRT transaction. It may be highly advantageous for a customer seeking to de-risk to receive a price which reduced the cash outlay. It may be highly advantageous for a customer to be able to strike a price if and when a target cash outlay is reached. It is noted that customers may have a variety of business objectives which may include the price of the PRT transaction, the cash outlay, or the timing of the transaction. Moreover, where multiple objectives are present there may be conflicts between these objectives. The present disclosure allows for users to review historical data to better understand relationships between these objectives and to better inform their future decisions as to when is an appropriate price to strike.

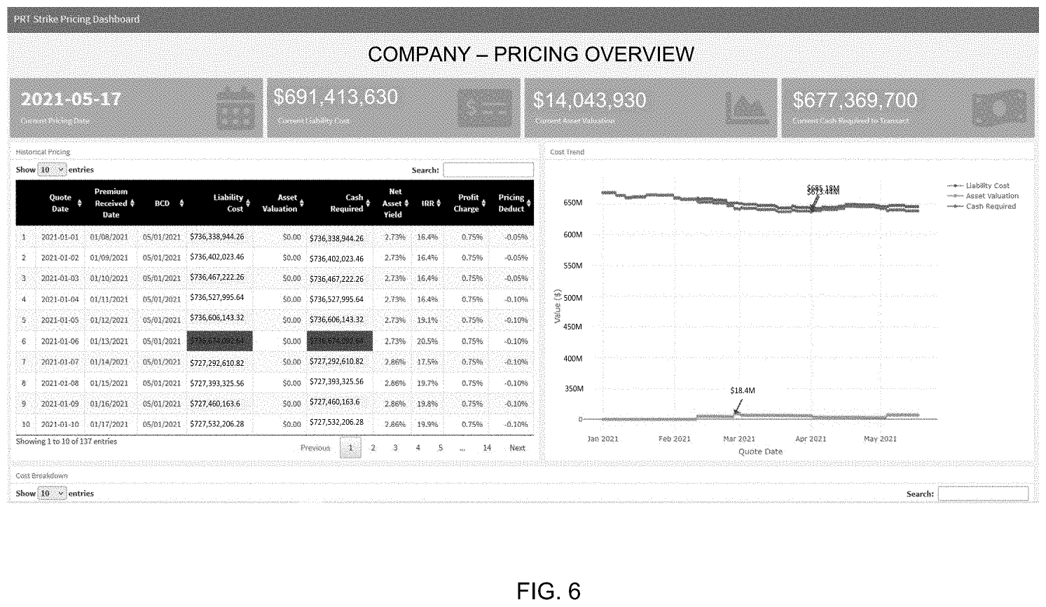

FIG. 6 illustrates one example of a screen display associated with a user interface. The screen display of FIG. 6 may be provided as a component of the user interface 133 of FIG. 1 or the user interface 142 of FIG. 1 when used by a client.

As shown in FIG. 6 the user interface may include a dashboard which is a type of user interface on a display that may be used to present a plurality of different types of information such as through including one or more graph components such that multiple types of information is communicated to a user in useful manner which allows them to use any or all of the available data to drive decisions or processes.

Prominently displayed such as at the top and/or in larger fonts, key metrics may be displayed. This may include the current pricing date, the current liability cost or PRT price, the current asset valuation, and the current cash required to transact or cash outlay. This information may also be conveyed historically such as within a table, on a graph, or both. Additional information may also be included especially for when the user interface is used for users associated with the organization providing the PRT pricing service as opposed to clients of that organization.

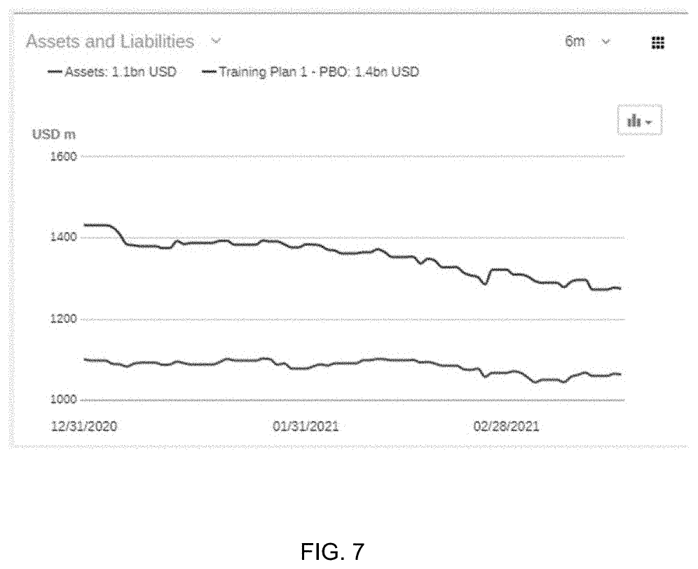

FIG. 7 illustrates an additional graph component as may be shown on a screen display associated with the user interface such as on a dashboard. The component of FIG. 7 may be provided as a component of the user interface 133 of FIG. 1 or the user interface 142 of FIG. 1 when used by a client. FIG. 1 shows assets and liabilities association with a plan. Such a graph component may be used by a client to better understand changes over time in the investment value of their plan which they are seeking risk transfer.

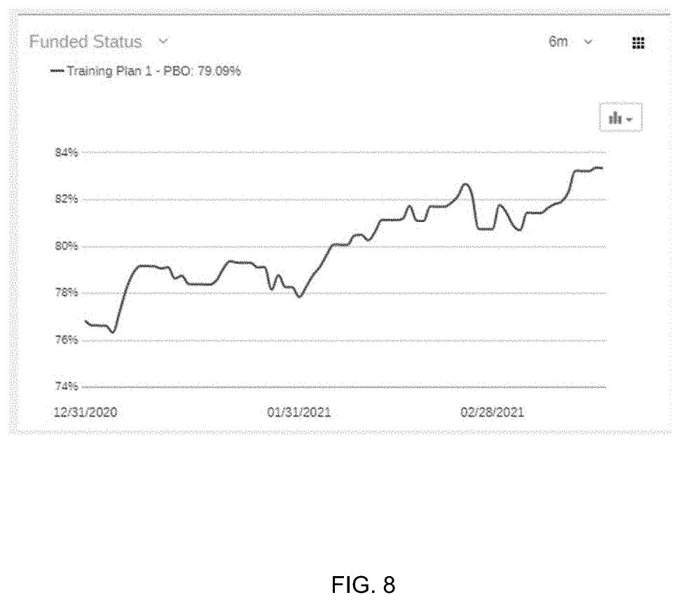

FIG. 8 may be used as an additional graph component such as may be shown on a screen display associated with the user interface such as on a dashboard. The component of FIG. 8 may be provided as a component of the user interface 133 of FIG. 1 or the user interface 142 of FIG. 1 when used by a client. Such a graph component may be used to show the percentage of funding that a pension plan has relative to their accounting target at various points in time.

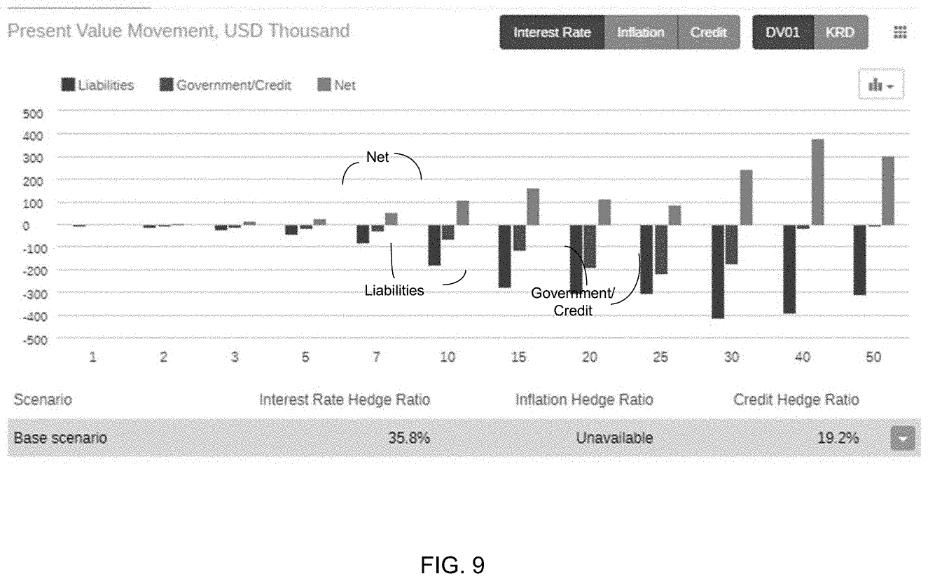

FIG. 9 may be used as an additional graph component such as may be shown on a screen display associated with the user interface such as on a dashboard. The component of FIG. 9 may be provided as a component of the user interface 133 of FIG. 1 or the user interface 142 of FIG. 1 when used by a client. Such a graph may be used to show movement of the present value. The net present value may be determined from the difference between liabilities and government/credit. Interest rate hedge ratios, inflation hedge ratio, and credit hedge ratios may also be shown.

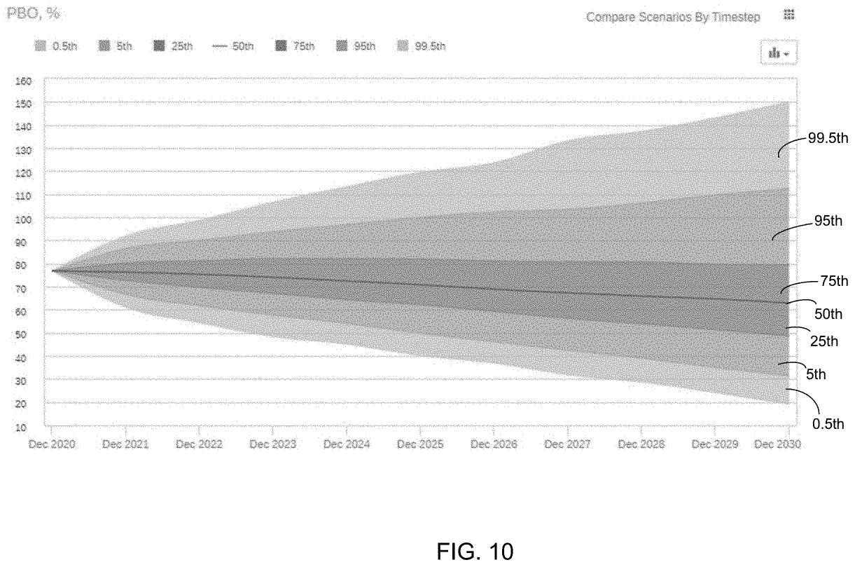

FIG. 10 may be used as an additional graph component such as may be shown on a screen display associated with the user interface. The component of FIG. 10 may be provided as a component of the user interface 133 of FIG. 1 or the user interface 142 of FIG. 1 when used by a client. Such a graph may be used to show a projected benefit obligation (PBO) which is an actuarial measurement of what a company will need at the present time to cover future pension liabilities. Thus, clients can take into consider projected benefit obligations in deciding when to strike. This is one example of the type of robust scenario modelling which may be implemented.

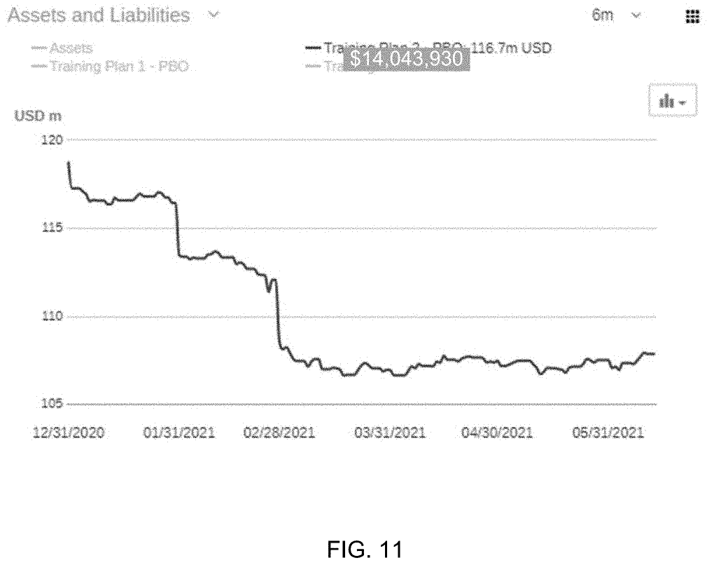

FIG. 11 may be used as an additional graph component such as may be shown on a screen display associated with the user interface. The component of FIG. 11 may be provided as a component of the user interface 133 of FIG. 1 or the user interface 142 of FIG. 1 when used by a client. Such a graph may be used to show assets and liabilities over time.

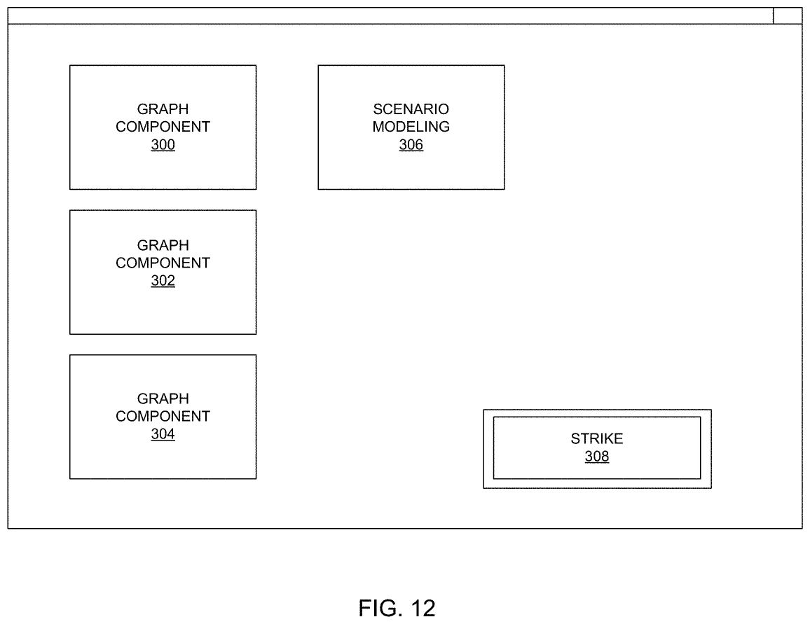

FIG. 12 illustrates another example of a user interface. The user interface may be in the form of a dashboard which may include a plurality of graph components 300, 302, 304. One or more scenario modelling tools 306 may also be shown. The scenario modeling tools may be used in a variety of different ways. The user interface may provide for receiving input from a user to execute a strike or complete a transaction. One example of such an input may be a button 308. To complete the transaction a user may need to confirm their selection and electronically a purchase agreement or other contract document.

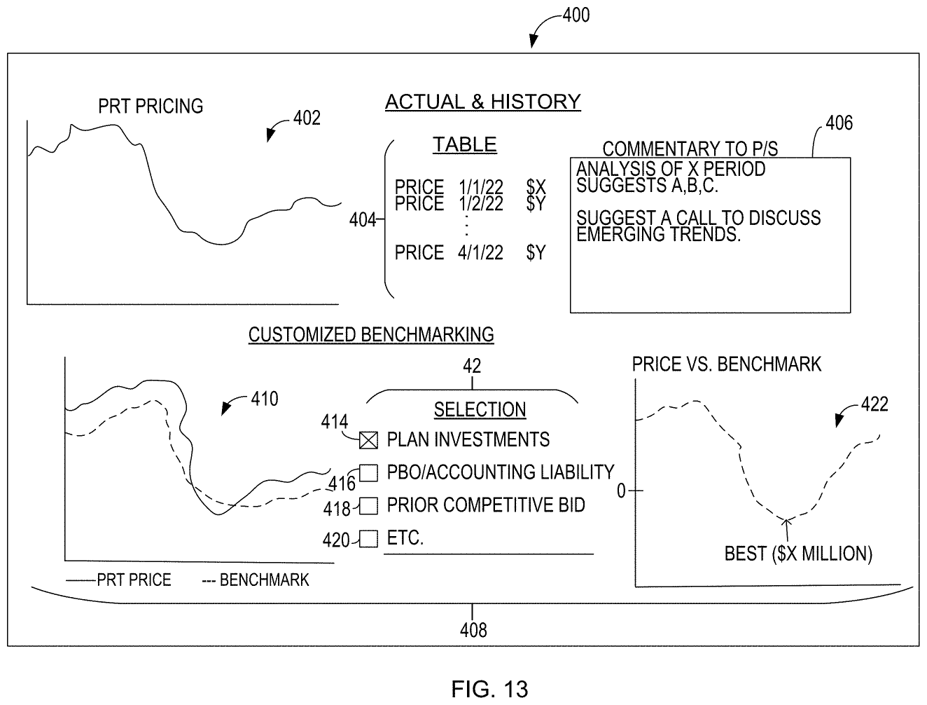

FIG. 13 is a screen display 400 showing price history, analysis, and price performance relative to a custom benchmark. At the left, a price history graph 402 is shown. The price history graph 402 may show daily pricing or other time scales may be used. A price history table 404 is also shown which may correspond with the price history graph 402. A commentary box 406 is also shown. The commentary box 406 may provide results of analysis to a user. Results of an analysis may include suggestions for actions to be taken, including suggestions to have a call or other communication to discuss emerging trends. The analysis and resulting commentary displayed in the commentary box 406 may be as a result of automated or manual analysis. In some embodiments, thresholds may be set for pricing, volatility in pricing, or other analytical results and meeting one or more of the thresholds may result in an appropriate comment being generated in the commentary box 406. Other types of analysis may include statistical analysis of a target price being met within a particular time frame, or other types of analysis. Additional visuals to summarize the change in prices over time into distinct groups such as changes in price from demographics, capital markets, pricing assumptions, and other drivers could be used.

Customized benchmarking may also be present. For example, as shown in graph 410, price performance may be displayed relative to a custom benchmark such as may be a set by a user. A user may choose a selection to customize including plan investments 414, PBO/Accounting liability 416, prior competitive bid 418, or other selection 420. Another price versus benchmark graph 422 is shown with a lowest or best price identified.

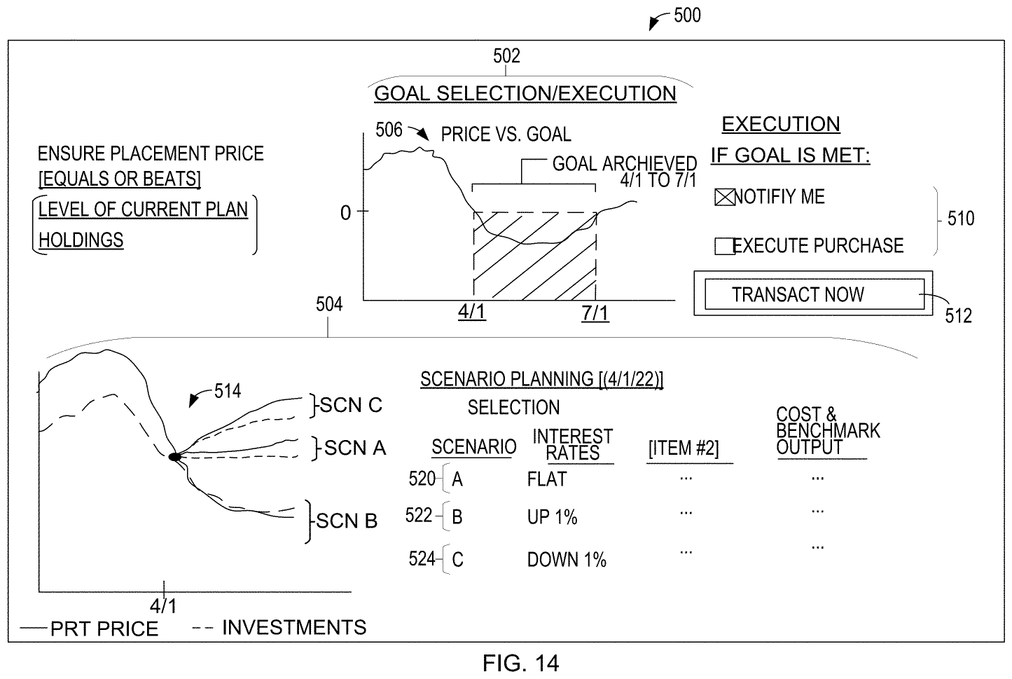

FIG. 14 is a screen display 500 showing goals and objectives with dynamic backtesting as well as scenario planning. A goal selection/execution aspect 502 is shown. A price versus goal graph 506 is shown so that a user can identify when a goal was achieved. Pricing may be monitored and settings 510 may allow for taking action upon occurrence of an event. For example, if a goal is met, a notification may occur. The notification may be an automated notification such as an email, a text message, a phone call, or other type of notification. In addition, or alternatively, if a goal is met a purchase may be executed automatically. Thus, a user may automatically complete execution instead of monitoring price or other goals. A transact now button 512 is also shown which allows a user to manually complete a transaction.

The goal selected may be based on occurrence of any number of different variables. Although in some embodiments, the goal may directly correspond to a price, the goal may be otherwise defined. For example, the goal may be based on pricing, the date, change in pricing, etc. Such goals may allow for the opportunity to obtain a desired price while also preserving opportunities to potentially receive a better price.

FIG. 14 also shows a scenario planning portion 504. A graph 514 is shown which may show both the historic price and/or investments as well as potential scenarios such as scenarios 520, 522, 524. In a first scenario 520, flat interest rates may be assumed. In a second scenario 522, a 1 percent increase in interest rates is assumed. In a third scenario 524, a 1 percent decrease in interest rates is assumed. Thus, a user can visualize and/or understand the potential effects of changes in different variables affecting value of investments and PRT pricing. In some embodiments, statistical analyses may be performed which are associated with different potential scenarios. The scenario planning portion 504 serves as a tool to help users better understand future pricing, benchmarks, or other sensitive criteria.

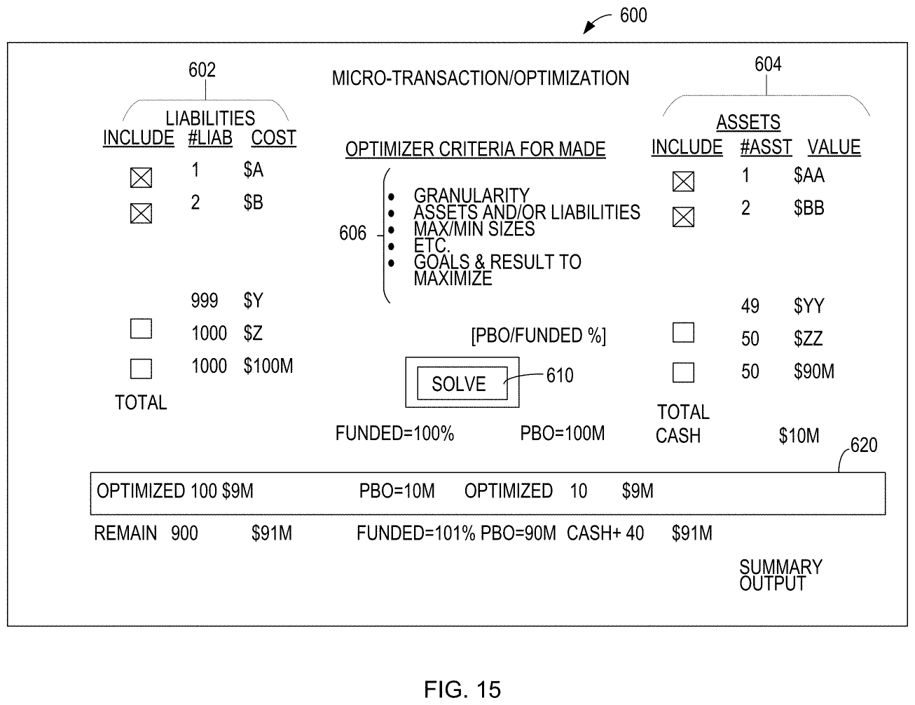

FIG. 15 is a screen display 600 illustrating one example of a micro-transaction optimizer that can display cost at a very granular level—down to the single participant and down to the single plan holding. In some embodiments it is contemplated that in order to reduce or pricing or price risk, transactions may occur at a granular level. Criteria may be available to allow a variety of criteria to be defined and/or optimized and an inherent model in strike pricing may be used to select micro transactions that best accomplish desired goals. For example, the level of granularity may be specified, assets and/or liabilities may be specified, the maximum or minimum sizes of transactions may be set, and other desired goals or result to maximize may be specified. As shown in FIG. 15, a set of liabilities 602 is shown and a set of assets 604 is shown. After a user has made selections of different liabilities and/or assets to be included, an optimization with optimization criteria 606 may be performed when a user selects a solve button 610. Results 620 showing that after a micro-transaction has been completed, the corresponding portion of the plan holdings have been optimized. The optimization may take into account any projected costs for associated with not making the transaction or with making the transaction.

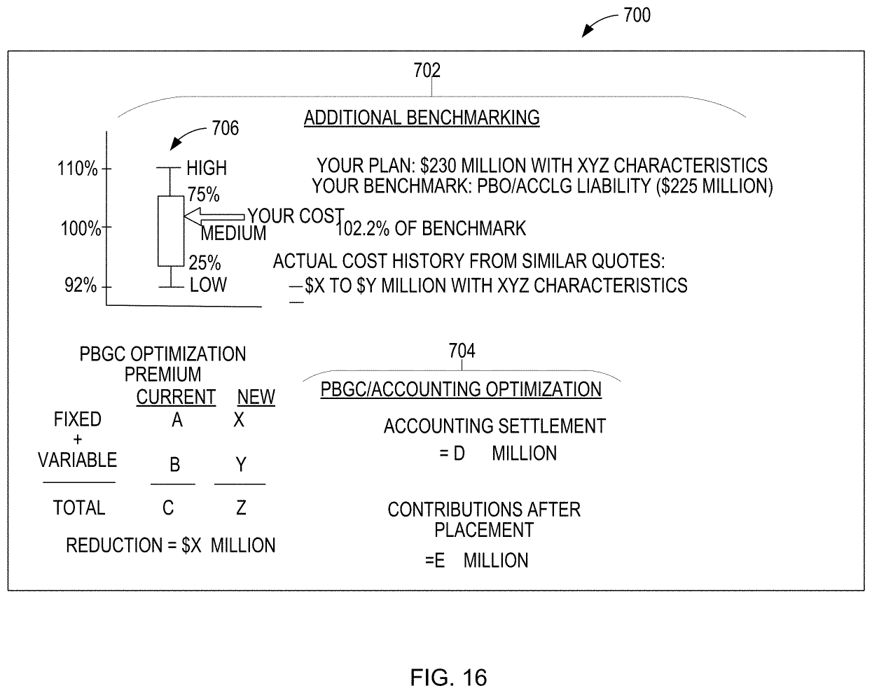

FIG. 16 is a screen display 700 which shows additional benchmarking 702 to leverage past observed prices for similar cases and to where current pricing compares. Such an analysis may be considered a “peer analysis.” This display leverages past transaction history which is obtained from any number of sources. Pension Benefit Guaranty Corporation (PBGC)/Accounting or other optimizations 704 are shown. This aspect allows for optimization of other components of the placement like PBGC premiums, accounting settlement costs, or other aspects that an actuary or other appropriate person may want to monitor and/or optimize.

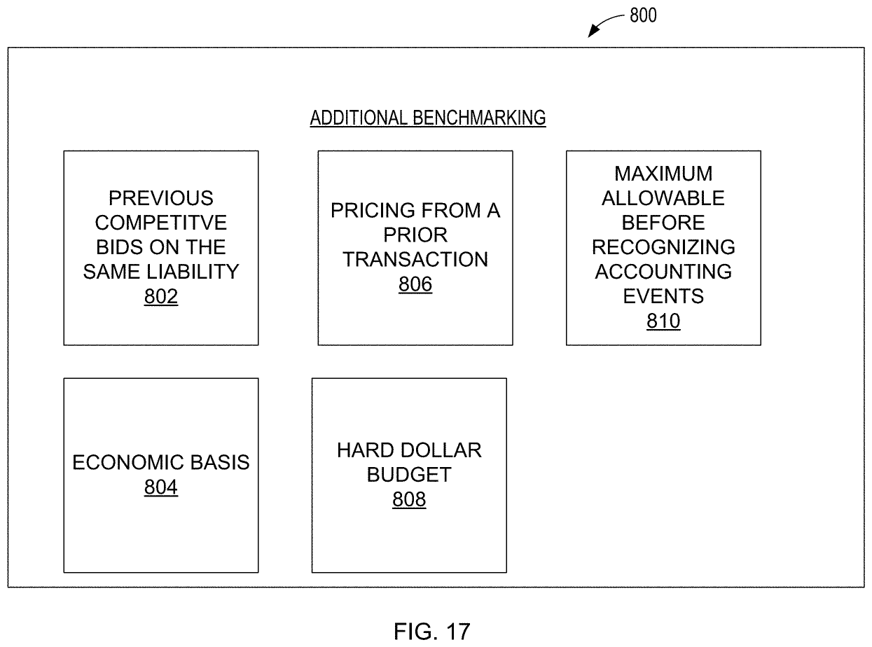

FIG. 17 is another example of a screen display 800 which provides for showing additional benchmarking. Examples of other types of benchmarking which may be shown include previous competitive bids on the same liability 802, economic basis benchmarking 804, pricing from a prior transaction benchmarking 806, hard dollar budget benchmarking 808, and maximum allowable before recognizing accounting events benchmarking 810. In the economic basis benchmarking 804, it is to be understood that this may different than a projected benefit obligation (PBO) if the discount rate or mortality rate using in a PBO calculation is inconsistent with the market. One example of pricing from a prior transaction benchmarking 806 would be the percent of a PBO achieved on the last transaction but applied to the current PBO. In some instances a client's board of directors may approve a particular hard dollar budget for the transaction. The hard dollar budget benchmarking 808 allows for making comparisons to this budget. The maximum amount allowable before recognizing account events 810 may recognize accounting events such as settlement account. Therefore, numerous types of benchmarking are contemplated to help clients and their consultants to better understand transactions. Benchmarking may be illustrated in various ways including through the use of graphs, charts, tables, or other graphic and/or textual information.

Thus, it should be appreciated the PRT pricing service allows clients the ability and the flexibility to transact or strike on any business day while also serving as a hub for price optimization and providing a holistic view of plan assets and liabilities. Thus, plan sponsors may receive daily, transactable quotes over a period of weeks or months and can choose to transact on any date. This gives plan sponsors the ability to monitor and avoid market interest rate volatility and select a quote that fits their business and financial needs.

The user interface and its accompanying dashboard may be used to track historical and current PRT pricing, asset valuation, and cash needed to transact each business day. In some embodiments, a script may be executed each morning to send current pricing inputs to the PRT pricing model. Inputs sent to this model daily include plan census data (gender, date of birth, monthly benefit amount, option form, state of residence, zip code, co-annuitant information), quote date, premium receipt date, retiree benefit commencement date, and expense assumptions. The PRT pricing model may be created as an actuarial model such as using a statistical program such as R. These inputs may then be combined with insurer-specific PRT pricing assumptions such as mortality, profitability targets, and current interest rates. The outputs of this model may include the net pricing rate, an overall quote/price, and life-by-life quote breakdown. The net pricing rate, quote or “liability cost”, yield curve and pricing deduct details, and transition timing details may be automatically loaded into a dashboard. In addition, the same script or a different script may run each morning to pull the value of the plan sponsor's separate account assets each day. After the one or more scripts are executed, the user interface or dashboard may each day, the dashboard will show the daily liability cost, asset valuation, and the difference between those two numbers as the cash required to transact. Thus, the dashboard may include a historical pricing section. The dashboard may also include a cost trend section to show these three values over time in a line graph format. The cost breakdown at the bottom of the dashboard tracks the daily premium change and a breakdown of what drives the daily change. Reasons for a premium change may include changes to net asset yield, gross rate, deducts, premium receipt date, benefit commencement date, census data, and pricing targets. The dashboard may show both the total daily premium change and the breakdown of premium change attributable to each driver.

It should be further understood that for a given client or potential client, their plan may be back tested to show a robust history of executable prices. This allows the client to see the value of the PRT strike pricing service.

In some examples, the PRT strike pricing service may run daily pricing for retirees under a retiree lift-out transaction model. In another example, the PRT strike pricing service may provide automated deferred pricing capabilities to run daily pricing for deferred lives under a plan termination transaction model.

It is further to be understood that the dashboard may provide a number of monitoring tools and analytical tools to assist client in defining and meeting their goals. This includes the ability to benchmark, generate different scenarios, perform and optimize microtransactions, and number of other functions and features.

Although specific models are shown and described, the present invention contemplates various options and alternatives. The methods described herein or aspects thereof may be incorporated into software in the form of instructions stored on a non-transitory computer or machine readable medium.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments may be described herein as implementing mathematical, statistical, and/or actuarial methodologies including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors such as central processing units (CPUs) or graphics processing units (GPUs) that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules. Where the term “processor” is used, it is to be understood that it encompasses one or more processors whether located together or remote from one other.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

The performance of certain of the operations may be distributed among the one or more processors, not only residing within a single machine, but deployed across a number of machines. In some example embodiments, the one or more processors or processor-implemented modules may be located in a single geographic location. In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment or example.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function or “step for [perform]ing [a function] . . . ”, it is intended that such elements are to be interpreted under 35 U.S.C. 112§ (f). However, for any claims containing elements designated in any other manner, it is intended that such elements are not to be interpreted under 35 U.S.C. § 112(f).

The invention is not to be limited to the particular embodiments described herein. In particular, the invention contemplates numerous variations in the specific methodology used. The foregoing description has been presented for purposes of illustration and description. It is not intended to be an exhaustive list or limit any of the invention to the precise forms disclosed. It is contemplated that other alternatives or exemplary aspects are considered included in the invention. The description is merely examples of embodiments, processes, or methods of the invention. It is understood that any other modifications, substitutions, and/or additions can be made, which are within the intended spirit and scope of the invention.

What is claimed is:

1. A computer-implemented method executed by at least one processor, the method comprising:
communicating over a computer network a plurality of inputs to a pension risk transfer pricing service for a pension plan, the plurality of inputs including pension plan census data;
applying by the pension risk transfer pricing service a computer-implemented pension risk transfer model for generating pension risk transfer pricing for the pension plan;
providing through the pension risk transfer pricing service a user interface for interacting with a user by communicating the pension risk transfer pricing and investments to the user and the user interface configured such that the user is able to strike the pension risk transfer at the pension risk transfer pricing.

2. The computer-implemented method of claim 1 wherein the user interface comprises a dashboard comprising a plurality of components.

3. The computer-implemented method of claim 2 wherein the components include a component showing assets and liabilities associated with the pension plan.

4. The computer-implemented method of claim 3 wherein the components include one or more components for displaying at least one of funded status, present value movement, and projected benefit obligations.

5. The computer-implemented method of claim 1 wherein the user interface is configured to display assets and liabilities associated with the pension plan, funded status, present value movement, and projected benefits obligations.

6. The computer-implemented method of claim 1 wherein the plurality of inputs further comprising pension risk transfer pricing assumptions and capital market data.

7. The computer-implemented method of claim 6 wherein the plurality of inputs further include investment portfolio data.

8. The computer-implemented method of claim 6 wherein the pension risk transfer pricing assumptions include mortality assumptions, profitability targets, and current interest rates.

9. The computer-implemented method of claim 1 further comprising analyzing provisions of the pension plan by applying machine learning and inputting resulting standardized provisions for the plan into the pension risk transfer model.

10. The computer-implemented method of claim 1 further comprising generating a purchase agreement and wherein the user executes the purchase agreement when the user uses the user interface to strike the pension risk transfer at the pension risk transfer pricing.

11. The computer-implemented method of claim 1 further comprising providing through the user interface of the pension risk transfer pricing service a dashboard comprising a plurality of components and wherein at least one of the components provides for optimizing micro-transactions for the pension plan.

12. A computer-implemented method performed using at least one processor, the method comprising:
communicating over a computer network a plurality of inputs to a pension risk transfer pricing service for a pension plan, the plurality of inputs including pension plan census data;
applying by the pension risk transfer pricing service a computer-implemented pension risk transfer model for generating pension risk transfer pricing for the pension plan;
providing through the pension risk transfer pricing service a user interface for interacting with a user by communicating the pension risk transfer pricing and investments to the user and the user interface configured such that the user is able to strike the pension risk transfer at the pension risk transfer pricing; and
providing through the user interface benchmarking functionality to select a benchmark and to visually display a comparison of the pension risk transfer pricing to the benchmark.

13. The computer-implemented method of claim 12 further comprising providing through the user interface goal selection functionality to visually display pricing relative to a defined goal.

14. The computer-implemented method of claim 13 further comprising providing through the user interface scenario planning functionality to visually display multiple scenarios based on alternative assumptions.

15. The computer-implemented method of claim 14 further comprising providing through the user interface micro-transaction functionality to display assets and/or liabilities of the pension plan at a granular level.

16. The computer-implemented method of claim 15 further comprising providing through the user interface additional benchmarking functionality to visually compare the pension plan with actual cost history from other pension plans.
